(19) United States
(12) Patent Application Publication
(10) Pub. No.: US 2025/0140472 A1
(43) Pub. Date: May 1, 2025

(54) CAPACITOR

(71) Applicant: Murata Manufacturing Co., Ltd., Nagaokakyo-shi (JP)

(72) Inventor: Toshiyuki NAKAISO, Nagaokakyo-shi (JP)

(21) Appl. No.: 19/009,406

(22) Filed: Jan. 3, 2025

Related U.S. Application Data
(63) Continuation of application No. PCT/JP2023/024716, filed on Jul. 4, 2023.

(30) Foreign Application Priority Data
Jul. 13, 2022 (JP) 2022-112345

(51) Int. Cl. H01G 2/20; H01G 4/33

(52) U.S. Cl. CPC H01G 2/20; H01G 4/33

(57) ABSTRACT

A capacitor that includes: a first electrode; a dielectric body on a surface of the first electrode; a second electrode on a surface of the dielectric body and facing the first electrode across the dielectric body; an externally connecting terminal electrode on a surface of the second electrode and electrically connected to the second electrode; and an insulating film covering the second electrode, the dielectric body, a portion excluding an externally connecting portion of the terminal electrode, and a part of the first electrode, wherein, when a thickness of the dielectric body is represented by Td and a shortest distance along a surface of the insulating film that connects a first portion of the terminal electrode that is not covered with the insulating film and a second portion of the first electrode that is not covered with the insulating film is represented by Tsr, Tsr<18×Td².

### CROSS REFERENCE TO RELATED APPLICATIONS

The present application is a continuation of International application No. PCT/JP2023/024716, filed Jul. 4, 2023, which claims priority to Japanese Patent Application No. 2022-112345, filed Jul. 13, 2022, the entire contents of each of which are incorporated herein by reference.

### TECHNICAL FIELD

The present disclosure relates to a capacitor formed by thin-film technology.

### BACKGROUND ART

Patent Literature 1 discloses a composite electronic component including a capacitor and an ESD protection element.

In Patent Literature 1, the ESD protection element includes a pair of discharge electrodes facing to each other via a gap, and a static-electricity absorption layer disposed between the pair of discharge electrodes. The static-electricity absorption layer is a composite of a sea-island structure in which an island-shaped conductive inorganic material is planarly and discontinuously distributed in the dielectric layer.

[Patent Literature 1] Japanese Unexamined Patent Application Publication No. 2015-23247

### BRIEF SUMMARY OF THE DISCLOSURE

However, the composite electronic component of Patent Literature 1 includes a discharge mechanism in a component and has a complex shape.

In view of the foregoing, exemplary embodiments of the present disclosure are directed to provide a capacitor having an ESD protection function with a simple configuration.

A capacitor according to the present disclosure includes: a first electrode; a dielectric body on a surface of the first electrode; a second electrode on a surface of the dielectric body and facing the first electrode across the dielectric body; an externally connecting terminal electrode on a surface of the second electrode and electrically connected to the second electrode; and an insulating film covering the second electrode, the dielectric body, a portion excluding an externally connecting portion of the terminal electrode, and a part of the first electrode, wherein, when a thickness of the dielectric body is represented by Td and a shortest distance along a surface of the insulating film that connects a first portion of the terminal electrode that is not covered with the insulating film and a second portion of the first electrode that is not covered with the insulating film is represented by Tsr, Tsr<18×Td².

In this configuration, when static electricity is applied to the terminal electrode, an electric charge by this static electricity flows from the terminal electrode into the lower electrode by aerial discharge along the outside of the surface of the insulating film, and is discharged from the lower electrode to a ground through another terminal electrode. As a result, the electric charge by the static electricity is significantly reduced from being applied to the dielectric body between the upper electrode and the lower electrode, and breakdown of the dielectric body is also significantly reduced. In such a manner, in this configuration, the breakdown of the dielectric body is significantly reduced without a separate discharging functional element.

According to the present disclosure, a capacitor having an ESD protection function is able to be achieved with a simple configuration.

### BRIEF DESCRIPTION OF THE DRAWINGS

FIG. 1A is a top view of a capacitor according to a first exemplary embodiment of the present disclosure, and FIG. 1B is a cross-sectional view taken along a line A-B shown in FIG. 1A.

FIG. 2 is an enlarged cross-sectional view of a vicinity of a side surface of the capacitor according to the first exemplary embodiment of the present disclosure and a vicinity of a side surface of a terminal electrode.

FIG. 3 is a side surface cross-sectional view showing a discharge state of static electricity in the capacitor according to the first exemplary embodiment.

FIG. 4 is a graph showing a relationship between breakdown of a dielectric body that configures a capacitance, a thickness Td, and the shortest distance Tsr.

FIG. 5A, FIG. 5B, FIG. 5C, FIG. 5D, and FIG. 5E are cross-sectional views of a configuration of the capacitor according to the first exemplary embodiment of the present disclosure, in respective manufacturing process steps.

FIG. 6A, FIG. 6B, FIG. 6C, and FIG. 6D are cross-sectional views of a configuration of the capacitor according to the first exemplary embodiment of the present disclosure, in respective manufacturing process steps.

FIG. 7A is a top view of a capacitor according to a second exemplary embodiment of the present disclosure, and FIG. 7B is a cross-sectional view taken along a line A-B shown in FIG. 7A.

FIG. 8 is an enlarged cross-sectional view of a vicinity of a side surface of the capacitor according to the second exemplary embodiment of the present disclosure and a vicinity of a side surface of a terminal electrode.

FIG. 9 is an enlarged cross-sectional view of a vicinity of a side surface of a capacitor according to a third exemplary embodiment of the present disclosure and a vicinity of a side surface of a terminal electrode.

FIG. 10A is a top view of a capacitor according to a fourth exemplary embodiment of the present disclosure, and FIG. 10B is a cross-sectional view taken along a line A-B shown in FIG. 10A.

FIG. 11 is a cross-sectional view of a capacitor according to a fifth exemplary embodiment of the present disclosure.

FIG. 12 is a cross-sectional view of a capacitor according to a sixth exemplary embodiment of the present disclosure.

FIG. 13 is a cross-sectional view of a capacitor according to a seventh exemplary embodiment of the present disclosure.

### DESCRIPTION OF EXEMPLARY EMBODIMENTS

### First Exemplary Embodiment

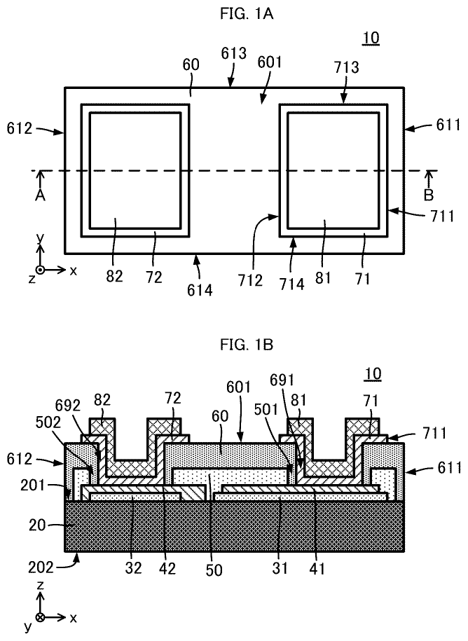

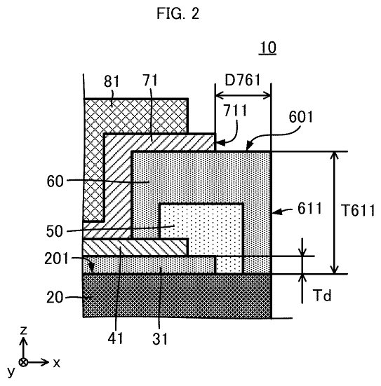

A capacitor according to a first exemplary embodiment of the present disclosure will be described with reference to the drawings. FIG. 1A is a top view of a capacitor according to the first exemplary embodiment of the present disclosure, and FIG. 1B is a cross-sectional view taken along a line A-B shown in FIG. 1A. FIG. 2 is an enlarged cross-sectional view of a vicinity of a side surface of the capacitor according to the first exemplary embodiment of the present disclosure and a vicinity of a side surface of a terminal electrode. It is to be noted that the views including FIG. 1A, FIG. 1B, and FIG. 2 that show the configuration of each exemplary embodiment of the present disclosure show the size in an exaggerated manner in order to facilitate understanding of the technology and to facilitate understanding of the configuration. In particular, the size in a z-axis direction is exaggerated.

### (Configuration of Capacitor 10)

As shown in FIG. 1A, FIG. 1B, and FIG. 2, the capacitor 10 includes a substrate 20, a dielectric body 31, a dielectric body 32, an electrode 41, an electrode 42, a protective film 50, an insulating film 60, a base electrode 71 for a terminal electrode, a base electrode 72 for a terminal electrode, an external connection electrode 81, and an external connection electrode 82.

The substrate 20 is a flat plate and has an upper surface 201 and a lower surface 202. The thickness of the substrate 20 is about 150 μm, for example. The substrate 20 is a conductive semiconductor, and is made of Si, for example. The resistivity of the substrate 20 may be 10 mΩ·cm, for example, and may be about 1 Ω·cm. The substrate 20 corresponds to an example of the “lower electrode” of the present disclosure.

The dielectric body 31 and the dielectric body 32 are disposed on the upper surface 201 of the substrate 20. The dielectric body 31 and the dielectric body 32 are flat films, for example, and has a rectangular shape in a top view (when viewed in a direction parallel to the z-axis direction). The dielectric body 31 and the dielectric body 32 are disposed apart from each other on the upper surface 201. For example, as shown in FIG. 1B, the dielectric body 31 and the dielectric body 32 are disposed apart from each other in an x-axis direction of the substrate 20.

The thickness of the dielectric body 31 and the dielectric body 32 is 1.0 μm, for example. The dielectric body 31 and the dielectric body 32 are made of SiO₂, for example. Although the dielectric body 31 and the dielectric body 32 may not have the same thickness and material, the same thickness and material make manufacturing easy and also easily align the height of the external connection electrode 81 and the external connection electrode 82 for easier mounting.

The electrode 41 is disposed on the upper surface of the dielectric body 31. More specifically, the electrode 41 is disposed on a surface of the dielectric body 31 facing a surface in contact with the substrate 20. In other words, the electrode 41 and the substrate 20 are disposed across the dielectric body 31.

In such a manner, capacitance is generated by a structure in which the electrode 41 and the conductive substrate 20 interpose the dielectric body 31, and this capacitance is determined by an area in which the electrode 41 and the substrate 20 face each other, a dielectric constant of the dielectric body 31, and the thickness of the dielectric body 31.

The thickness of the electrode 41 is 1.0 μm, for example. The electrode 41 is made of Al, for example.

The electrode 42 covers the dielectric body 32, together with the substrate 20. Specifically, the electrode 42 is disposed on the upper surface and each side surface of the dielectric body 32, and is electrically connected and physically connected to the substrate 20. The electrode 42 is not physically and directly connected to the electrode 41. The thickness of the electrode 42 is 1.0 μm, for example. The electrode 42 is made of Al, for example.

The protective film 50 is disposed near the upper surface of the substrate 20. The protective film 50 covers the upper surface 201 of the substrate 20, the dielectric body 31, the electrode 41, and the electrode 42. In such a case, the protective film 50 has a depression 501 that exposes a portion of the upper surface of the electrode 41, and a depression 502 that exposes a portion of the upper surface of the electrode 42.

The thickness of the protective film 50 is 0.8 μm, for example. The protective film 50 is made of SiN, for example. The protective film 50 is a so-called passivation layer.

The insulating film 60 covers the upper surface 201 of the substrate 20, and the protective film 50. In such a case, the insulating film 60 has a depression 691 having a bottom portion of which the vicinity is included by the depression 501 of the protective film 50 and exposing the upper surface of the electrode 41, and a depression 692 having a bottom portion of which the vicinity is included by the depression 502 of the protective film 50 and exposing the upper surface of the electrode 42. In other words, the insulating film 60 covers the electrode 41, the electrode 42, the dielectric body 31, the dielectric body 32, a portion excluding an externally connecting portion of the terminal electrode to be described below, and a portion (the upper surface 201) of the substrate 20.

The thickness of the insulating film 60 is 5.0 μm, for example. The insulating film 60 is an organic film made of a predetermined composition and having an insulating property, for example. The insulating film 60 is a so-called solder resist layer.

The base electrode 71 for a terminal electrode is disposed on an upper surface 601 of the insulating film 60, the inside of the depression 691, and a surface exposed by the depression 691 in the electrode 41. The base electrode 71 has a rectangular shape in a top view. The base electrode 71 is an electrode layer in which Ti and Cu are formed by a sputtering method in order, for example, and the thickness of Ti is 0.1 μm, and the thickness of Cu is 1.0 μm.

The external connection electrode 81 covers an upper surface of the base electrode 71. The external connection electrode 81 is a plating layer in which Ni and Au are formed in order, for example, and the thickness of Ni is 3.0 μm, and the thickness of Au is 0.1 μm.

The base electrode 71 and the external connection electrode 81 configure the “terminal electrode” (an upper-electrode terminal electrode) of the present disclosure.

The base electrode 72 for a terminal electrode is disposed on the upper surface 601 of the insulating film 60, the inside of the depression 692, and a surface exposed by the depression 692 in the electrode 42. The base electrode 72 has a rectangular shape in a top view. The base electrode 72 is an electrode layer in which Ti and Cu are formed by a sputtering method in order, for example, and the thickness of Ti is 0.1 μm, and the thickness of Cu is 1.0 μm.

The external connection electrode 82 covers an upper surface of the base electrode 72. The external connection electrode 82 is a plating layer in which Ni and Au are formed in order, for example, and the thickness of Ni is 3.0 μm, and the thickness of Au is 0.1 μm.

The base electrodes 72 and the external connection electrode 82 configure a terminal electrode, more specifically, the “lower-electrode terminal electrode” of the present disclosure. The base electrode 71 and the base electrode 72, or the terminal electrode 81 and the terminal electrode 82 are schematically represented by a rectangle. However, a corner portion may be rounded, or a portion corresponding to a corner by rounding may be formed at an angle greater than 90 degrees.

With the above configuration, the capacitor 10 achieves a capacitor (a MIM capacitor) formed by the thin-film technology.

### (Specific Description of Discharge Function of Capacitor 10)

As shown in FIG. 2, in the capacitor 10, a side surface 711 of the base electrode 71 for a terminal electrode is in contact with the upper surface 601 of the insulating film 60 and is disposed near a side surface 611 of the insulating film 60.

A distance between the side surface 711 and the side surface 611 of the insulating film 60 is represented by D761. More specifically, the distance D761 is the shortest distance between the side surface 711 and the side surface 611 along the upper surface 601 of the insulating film 60.

The thickness of the insulator is represented by T611. More specifically, the thickness T611 is the shortest distance between a point at which a straight line configuring the distance D761 is in contact with the side surface 611 and a side surface of the substrate 20 along the side surface 611 in a thickness direction (the z-axis direction) of the insulating film 60.

Accordingly, a distance obtained by adding the distance D761 and the thickness T611 is the shortest distance between the terminal electrode and the substrate 20 along an outer surface of the insulating film 60. This shortest distance is represented by Tsr (Tsr=D761+T611).

In addition, the thickness of the dielectric body 31 is represented by Td.

Then, the shortest distance Tsr and the thickness Td satisfy the following relationship.

$$Tsr < 18 \times {Td}^{2} - \qquad ( Formula 1 )$$

This relationship is satisfied, which obtains the following operational effects.

It is to be noted that, as an example, a combination of the distance D761 of about 8 μm and the thickness T611 of about 8 μm is considered with respect to the thickness Td of the dielectric body of about 1.0 μm.

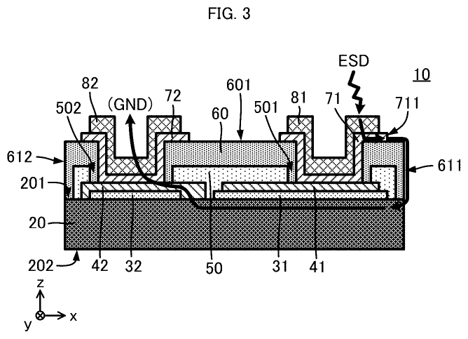

FIG. 3 is a side surface cross-sectional view showing a discharge state of static electricity in the capacitor according to the first exemplary embodiment.

As shown in FIG. 3, electrostatic discharge (ESD) is applied to the terminal electrodes (the external connection electrode 81 and the base electrode 71) from outside.

Herein, under the relationship that satisfies Formula 1, a voltage generated by the electric charge of static electricity is discharged into air in a path (an air path) through the surface of the insulating film 60 earlier than reaching a breakdown voltage of the dielectric body 31, and the electric charge of static electricity flows into the substrate 20.

The substrate 20 is electrically connected to the lower-electrode terminal electrode (the external connection electrode 82 and the base electrode 72) to be connected to an external ground potential through the electrode 42. Accordingly, the electric charge flowing into the substrate 20 is discharged to a ground through the electrode 42 and the lower-electrode terminal electrode.

As a result, the electric charge by static electricity is significantly reduced from being applied to the dielectric body 31 between the electrode 41 and the substrate 20. Accordingly, breakdown of the dielectric body 31 is significantly reduced.

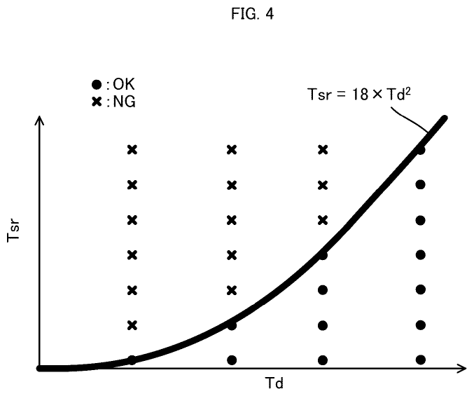

FIG. 4 is a graph showing a relationship between the breakdown of the dielectric body that configures a capacitance, the thickness Td, and the shortest distance Tsr. In FIG. 4, a solid line shows a curve (a function) obtained by replacing the inequality sign of (Formula 1) with an equal sign. In addition, FIG. 4 shows a state of the breakdown of the dielectric body in a case in which 1-kV static electricity of HBM is applied to the terminal electrode, and OK represents absence of the breakdown, and NG represents presence of the breakdown.

As shown in FIG. 4, no breakdown in the dielectric body occurs when (Formula 1) is satisfied, and the breakdown occurs when (Formula 1) is not satisfied.

It is to be noted that, although 1 kV is used herein as an example, the same or similar tendency is obtained also at 2 kV and 5 kV.

In such a manner, the relationship of (Formula 1) is satisfied, so that the capacitor 10 is able to significantly reduce the breakdown of the dielectric body 31.

Then, the capacitor 10 has no separate new discharging functional element as in the conventional technology. As a result, the capacitor 10 is able to significantly reduce the breakdown of the dielectric body 31 with a simple configuration. In addition, the capacitor 10 is able to achieve a reduction in thickness and size more than the configuration with a separate new discharging functional element as in the conventional technology.

### (One Example of Method of Manufacturing Capacitor 10)

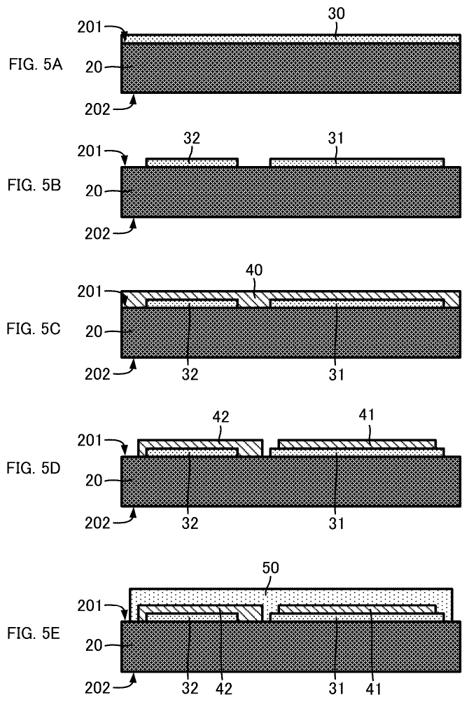

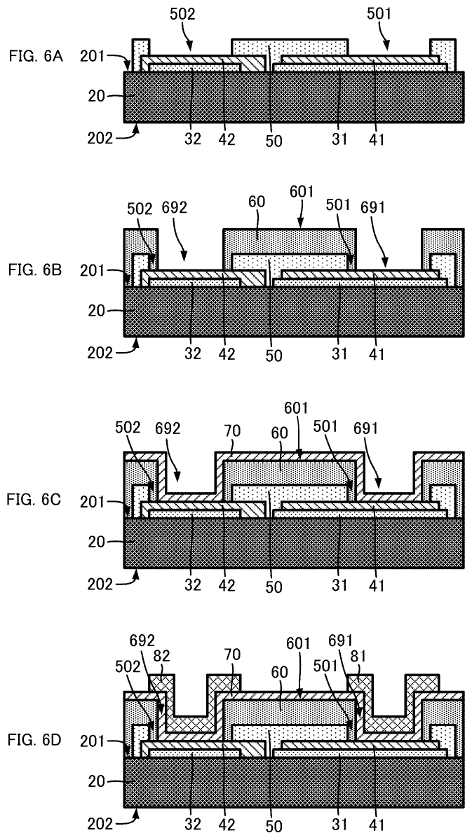

FIG. 5A, FIG. 5B, FIG. 5C, FIG. 5D, FIG. 5E, FIG. 6A, FIG. 6B, FIG. 6C, and FIG. 6D are cross-sectional views of a configuration of the capacitor according to the first exemplary embodiment of the present disclosure, in respective manufacturing process steps. It is to be noted that the following description of the manufacturing method will omit the description of the specific point in the above description of the configuration and provide only a newly required description.

The substrate 20 is supplied, as shown in FIG. 5A, to form a dielectric body 30 on the upper surface 201 of the substrate 20. For example, SiO₂ may be formed as a thermal oxide film on a Si substrate, or SiO₂ or a SiN film may be formed by CVD (Chemical Vapor Deposition).

The dielectric body 30 is pattern-etched, as shown in FIG. 5B, to form the dielectric body 31 and the dielectric body 32.

As shown in FIG. 5C, the electrode 40 is formed near the upper surface 201 of the substrate 20 so as to cover the dielectric body 31 and the dielectric body 32. A metal such as Al and Cu may be formed using a vapor-depositing method, a sputtering method, plating, or the like.

The electrode 40 is pattern-etched, as shown in FIG. 5D, to form the electrode 41 and the electrode 42.

As shown in FIG. 5E, the protective film 50 (the passivation film) is formed near the upper surface 201 of the substrate 20 so as to cover the dielectric body 31, the electrode 41, and the electrode 42. The protective film may be made of SiO₂, SiN, or the like by CVD or a spin coating.

The protective film 50 is pattern-etched, as shown in FIG. 6A, to form a depression 501 that exposes a portion of the upper surface of the electrode 41 and a depression 502 that exposes a portion of the upper surface of the electrode 42, on the protective film 50.

As shown in FIG. 6B, the insulating film 60 is formed so as to cover the protective film 50. In such a case, the insulating film 60 has the depression 691 and the depression 692.

As shown in FIG. 6C, a power supply film 70 is formed so as to cover the upper surface 601 of the insulating film 60, a wall surface of the depression 691, and a wall surface of the depression 692. The power supply film 70 is achieved by sputtering and electroless plating, for example.

As shown in FIG. 6D, the external connection electrode 81 and the external connection electrode 82 are formed so as to include regions of the depression 691 and the depression 692 in the power supply film 70. The external connection electrode 81 and the external connection electrode 82 are achieved by electrolytic plating using, for example, a mask.

Subsequently, the power supply film 70 is pattern-etched to form the base electrode 71 and the base electrode 72.

The processing up to this point is performed on a mother substrate in which a plurality of capacitors 10 are arranged. Then, subsequently, the substrate 20 is properly ground from a side of the bottom surface 202 to cut out the mother substrate so as to be divided into individual pieces of the plurality of capacitors 10.

### Second Exemplary Embodiment

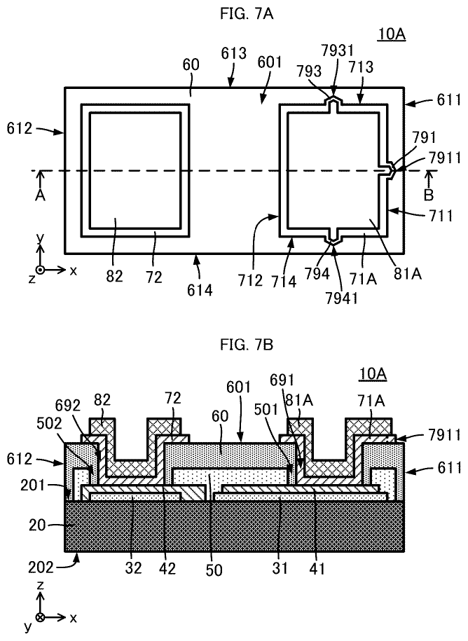

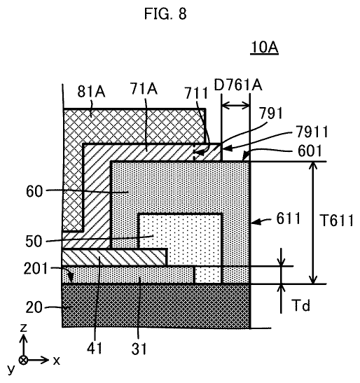

A capacitor according to a second exemplary embodiment of the present disclosure will be described with reference to the drawings. FIG. 7A is a top view of the capacitor according to the second exemplary embodiment of the present disclosure, and FIG. 7B is a cross-sectional view taken along a line A-B shown in FIG. 7A. FIG. 8 is an enlarged cross-sectional view of a vicinity of a side surface of the capacitor according to the second exemplary embodiment of the present disclosure and a vicinity of a side surface of a terminal electrode.

As shown in FIG. 7A, FIG. 7B, and FIG. 8, the capacitor 10A according to the second exemplary embodiment is different from the capacitor 10 according to the first exemplary embodiment in the configuration of a terminal electrode (a base electrode 71A, an external connection electrode 81A). Other configurations of the capacitor 10A are the same as or similar to the configurations of the capacitor 10, and a description of the same or similar configurations will be omitted.

The base electrode 71A has a rectangular shape in a top view and includes a side surface 711, a side surface 712, a side surface 713, and a side surface 714. The side surface 711 is adjacent to and parallel to the side surface 611 of the insulating film 60. The side surface 712 faces the side surface 711 and is the side surface of the base electrode 71A near the base electrode 72. The side surface 713 is adjacent to and parallel to the side surface 613 of the insulating film 60. The side surface 714 faces the side surface 713 and is adjacent to and parallel to the side surface 614 of the insulating film 60. It is to be noted that parallelism herein is not limited to perfect parallelism but includes a range of manufacturing errors.

The base electrode 71A includes a main portion, a projection 791, a projection 793, and a projection 794. The main portion of the base electrode 71A is a rectangular portion in the top view.

The projection 791, in the top view of the base electrode 71A, projects from the side surface 711 of the main portion toward the side surface 611 of the insulating film 60. In such a case, a width of the projection 791 is smaller than a width of the side surface 711.

The projection 793, in the top view of the base electrode 71A, projects from the side surface 713 of the main portion toward the side surface 613 of the insulating film 60. In such a case, a width of the projection 793 is smaller than a width of the side surface 713.

The projection 794, in the top view of the base electrode 71A, projects from the side surface 714 of the main portion toward the side surface 614 of the insulating film 60. In such a case, a width of the projection 794 is smaller than a width of the side surface 714.

In such a configuration, the further shortest distance among the shortest distance along the outer surface (the upper surface 601 and the side surface 611) of the insulating film 60 from a front end 7911 of the projection 791 to the side surface of the substrate 20, the shortest distance along the outer surface (the upper surface 601 and the side surface 613) of the insulating film 60 from a front end 7931 of the projection 793 to the side surface of the substrate 20, and the shortest distance along the outer surface (the upper surface 601 and the side surface 614) of the insulating film 60 from a front end 7941 of the projection 794 to the side surface of the substrate 20 is represented by the shortest distance Tsr.

For example, in a case of FIG. 8, the distance between the front end 7911 of the projection 791 and the side surface 611 of the insulating film 60 is represented by D761A, and the shortest distance Tsr is a value obtained by adding this distance D761A and the thickness T611. It is to be noted that, as an example, a combination of the distance D761A of about 3 μm and the thickness T611 of about 8 μm is considered with respect to the thickness Td of the dielectric body of about 1.0 μm.

With such a configuration, the capacitor 10A, similarly to the capacitor 10, discharges static electricity into air and is able to significantly reduce the breakdown of the dielectric body 31.

Furthermore, the capacitor 10A is able to control a position of the aerial discharge from the terminal electrode. In addition, the capacitor 10A is able to reduce the shortest distance Tsr without changing the position of the side surface 711 of the terminal electrode near the side surface 611 of the insulating film 60. As a result, the capacitor 10A, while maintaining discharge performance, is able to reduce the size of the terminal electrode, and is able to reduce parasitic capacitance generated by the terminal electrode and the substrate 20.

In addition, in the capacitor 10A, the front end 7911 of the projection 791, the front end 7931 of the projection 793, and the front end 7941 of the projection 794 have a tapered shape. As a result, the capacitor 10A is able to further control a discharge portion.

It is to be noted that the capacitor 10A shows an aspect including three projections (the projection 791, the projection 793, the projection 794). However, the number of projections is not limited to this aspect and may be at least one. Moreover, for example, two or more projections may be provided on one side surface.

In addition, the capacitor 10A, in a case of including the even number of projections such as two projections, may include a pair of projections on the side surface 713 and the side surface 714. As a result, even when misalignment occurs in a case in which the capacitor 10A is cut from the mother substrate and divided into individual pieces, either of the projection near the side surface 713 or the projection near the side surface 714 is disposed so as to certainly satisfy the above (Formula 1). As a result, the capacitor 10A is able to significantly reduce the breakdown of the dielectric body 31 more reliably.

### Third Exemplary Embodiment

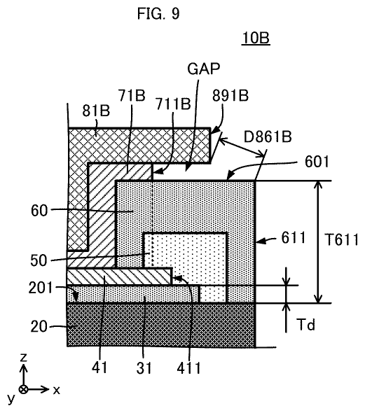

A capacitor according to a third exemplary embodiment of the present disclosure will be described with reference to the drawings. FIG. 9 is an enlarged cross-sectional view of a vicinity of a side surface of a capacitor according to the third exemplary embodiment of the present disclosure and a vicinity of a side surface of a terminal electrode.

As shown in FIG. 9, the capacitor 10B according to the third exemplary embodiment is different from the capacitor 10A according to the second exemplary embodiment in the configuration of a terminal electrode (a base electrode 71B, an external connection electrode 81B). Other configurations of the capacitor 10B are the same as or similar to the configurations of the capacitor 10A, and a description of the same or similar configurations will be omitted.

The outer shape of the external connection electrode 81B is larger than the outer shape of the base electrode 71B. For example, a side surface 891B of the external connection electrode 81B near the side surface 611 of the insulating film 60 projects closer to the side surface 611 than the side surface 711 of the base electrode 71B near the side surface 611 of the insulating film 60.

Then, in a portion of the external connection electrode 81B projecting farther than the base electrode 71B, a gap GAP is formed between the external connection electrode 81B and the insulating film 60. The gap GAP is about 0.1 μm to 2.0 μm, for example. Such a gap GAP is able to be achieved by performing selective etching in which the base electrode 71B is more easily etched than the external connection electrode 81B.

In such a configuration, a distance D861B between the side surface 891B of the external connection electrode 81B (the front end of the projection of the external connection electrode 81B corresponding to the projection 791, for example) and the side surface 611 of the insulating film 60 is able to be shorter than a distance between the side surface 711B of the base electrode 71B (the front end of the projection 791, for example) and the side surface 611 of the insulating film 60. In this case, the shortest distance Tsr is a value obtained by adding the distance D861B and the thickness T611.

With such a configuration, the capacitor 10B obtains the same or substantially the same advantageous operational effects as the capacitor 10B.

Furthermore, in the capacitor 10B, an area to be disposed on the upper surface 601 of the insulating film 60 in the base electrode 71B is able to be reduced. As a result, the capacitor 10B is able to significantly reduce parasitic capacitance generated between the electrode 41 and the base electrode 71B. In particular, as shown in FIG. 9, the side surface 711B of the base electrode 71B is farther from the side surface 611 of the insulating film 60 than the side surface of the electrode 41 near the side surface 611 of the insulating film 60 (see the dashed line of FIG. 9), an area in which the electrode 41 faces the base electrode 71B is able to be further reduced. Accordingly, the capacitor 10B is able to further reduce the parasitic capacitance generated between the electrode 41 and base electrode 71B.

Then, with such a structure as well, the external connection electrode 81B is able to significantly reduce the shortest distance Tsr from being increased, and is able to achieve aerial discharge in a desired voltage. Furthermore, the gap GAP is present in a region in which the external connection electrode 81B and the electrode 41 face each other without interposing the base electrode 71B, so that the capacitor 10B is able to significantly reduce the parasitic capacitance generated between the electrode 41 and the external connection electrode 81B.

### Fourth Exemplary Embodiment

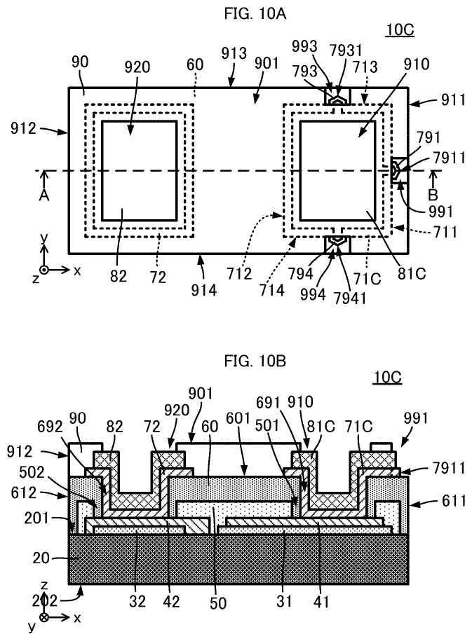

A capacitor according to a fourth exemplary embodiment of the present disclosure will be described with reference to the drawings. FIG. 10A is a top view of the capacitor according to the fourth exemplary embodiment of the present disclosure, and FIG. 10B is a cross-sectional view taken along a line A-B shown in FIG. 10A.

As shown in FIG. 10A and FIG. 10B, the capacitor 10C according to the fourth exemplary embodiment is different from the capacitor 10A according to the second exemplary embodiment in that an insulating film 90 is provided. Other configurations of the capacitor 10C are the same as or similar to the configurations of the capacitor 10A, and a description of the same or similar configurations will be omitted.

The insulating film 90 of the capacitor 10C covers the insulating film 60, a base electrode 71C (the same or substantially the same configurations as the base electrode 71A), the base electrode 72, an external connection electrode 81C (the same or substantially the same configurations as the external connection electrode 81A), and the external connection electrode 82. In such a time, the insulating film 90 exposes a central portion (a portion used as a mounting electrode) of the external connection electrode 81C in the top view, a central portion (a portion used as a mounting electrode) of the external connection electrode 82 in the top view, a portion of the base electrode 71C including the front end 7911 of the projection 791, a portion of the base electrode 71C including the front end 7931 of the projection 793, and a portion of the base electrode 71C including the front end 7941 of the projection 794 to the outside.

Although the insulating film 90 may be made of the same or substantially the same material as the insulating film 60 or may be made of a different material, the use of the same material is able to expect an improvement in adhesiveness between the insulating film 60 and the insulating film 90. The use of the same material may cause an indefinite boundary between the insulating film 60 and the insulating film 90.

With such a configuration, the capacitor 10C is able to reduce an impact during mounting. In addition, the capacitor 10C, since the projection is exposed from the insulating film 90, is able to significantly reduce the breakdown of the dielectric body 31 due to the aerial discharge of static electricity, as well as the capacitor 10A. In other words, the capacitor 10C obtains the same or substantially the same advantageous operational effects as the capacitor 10A.

### Fifth Exemplary Embodiment

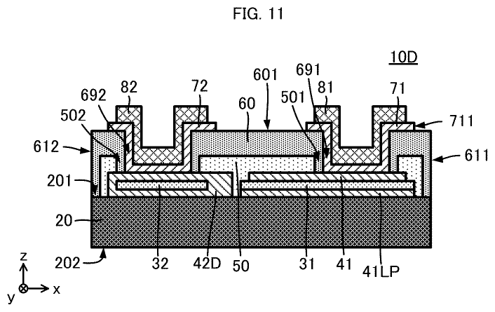

A capacitor according to a fifth exemplary embodiment of the present disclosure will be described with reference to the drawings. FIG. 11 is a cross-sectional view of the capacitor according to the fifth exemplary embodiment of the present disclosure. FIG. 11 shows a cross-sectional view taken along a line A-B as in FIG. 1A or the like.

As shown in FIG. 11, the capacitor 10D according to the fifth exemplary embodiment is different from the capacitor 10 according to the first exemplary embodiment in that an electrode 41LP is provided and an electrode 42D is provided instead of the electrode 42. Other configurations of the capacitor 10D are the same as or similar to the configurations of the capacitor 10, and a description of the same or similar configurations will be omitted.

The electrode 41LP is disposed between the substrate 20 and the dielectric body 31. The electrode 41LP is connected to the substrate 20. The electrode 41LP faces the electrode 41 across the dielectric body 31.

In this configuration, the electrode 41LP and the substrate 20 configure the “lower electrode” of the present disclosure.

The electrode 42D is provided in combination with the electrode 42 of the capacitor 10 and an electrode film formed at the same timing as the electrode 41LP, and covers the entire surface of the dielectric body 32.

With such a configuration, the capacitor 10D obtains the same or substantially the same advantageous operational effects as the capacitor 10.

### Sixth Exemplary Embodiment

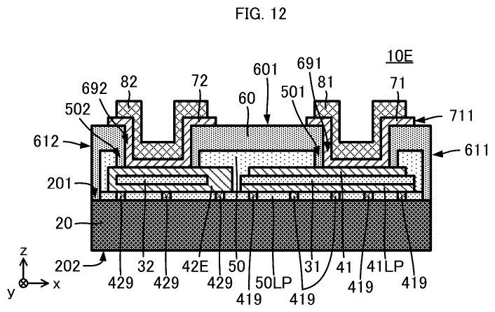

A capacitor according to a sixth exemplary embodiment of the present disclosure will be described with reference to the drawings. FIG. 12 is a cross-sectional view of the capacitor according to the sixth exemplary embodiment of the present disclosure. FIG. 12, similarly to FIG. 11, shows a cross-sectional view taken along a line A-B as in FIG. 1A or the like.

As shown in FIG. 12, the capacitor 10E according to the sixth exemplary embodiment is different from the capacitor 10D according to the fifth exemplary embodiment in that a lower protective film 50LP, a plurality of via conductors 419, and a plurality of via conductors 429 are provided. Other configurations of the capacitor 10E are the same as or similar to the configurations of the capacitor 10D, and a description of the same or similar configurations will be omitted.

The capacitor 10E includes the lower protective film 50LP on the upper surface 201 of the substrate 20. The lower protective film 50LP is made of the same or substantially the same material as the protective film 50, for example.

The lower protective film 50LP is disposed between the substrate 20 and the electrode 41LP, and are disposed between the substrate 20 and the electrode 42E (the same or substantially the same configuration as the electrode 42D).

The plurality of via conductors 419 are provided on the lower protective film and penetrate the lower protective film 50LP in the thickness direction. The plurality of via conductors 419 connect the substrate 20 and the electrode 41LP and are electrically connected to one another.

The plurality of via conductors 429 are provided on the lower protective film 50LP and penetrate the lower protective film 50LP in the thickness direction. The plurality of via conductors 429 connect the substrate 20 and the electrode 42E and are electrically connected to one another.

With such a configuration, the capacitor 10E obtains the same or substantially the same advantageous operational effects as the capacitor 10D.

### Seventh Exemplary Embodiment

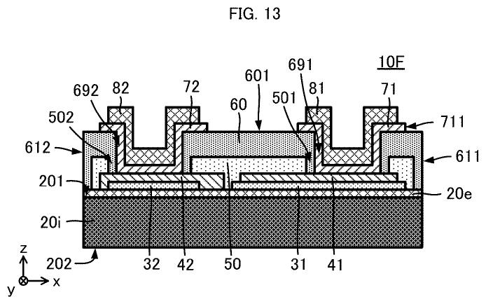

A capacitor according to a seventh exemplary embodiment of the present disclosure will be described with reference to the drawings. FIG. 13 is a cross-sectional view of the capacitor according to the seventh exemplary embodiment of the present disclosure. FIG. 13 shows a cross-sectional view taken along a line A-B as in FIG. 1A or the like.

As shown in FIG. 13, the capacitor 10F according to the seventh exemplary embodiment is different from the capacitor 10 according to the first exemplary embodiment in that an electrode 20e is provided and a substrate 20i is provided instead of the substrate 20. Other configurations of the capacitor 10F are the same as or similar to the configurations of the capacitor 10, and a description of the same or similar configurations will be omitted.

The substrate 20i is a substrate having an insulating property. The substrate 20i is made of alumina, for example.

The electrode 20e is disposed on the upper surface 201 of the substrate 20i. The electrode 20e has conductivity. The lower electrode, as described above, is achieved by the electrode 20e disposed on the insulating substrate 20i.

The dielectric body 31 and the dielectric body 32 are disposed on the upper surface (the surface facing a surface in contact with the substrate 20i) of the electrode 20e.

In the capacitor 10F, the thickness T611 is not the distance from the substrate but the distance from the electrode 20e.

With such a configuration, the capacitor 10F obtains the same or substantially the same advantageous operational effects as the capacitor 10.

Herein, for convenience, the shape of the insulating film 60 viewed in a y-axis direction, although shown as a rectangle, is not necessarily a rectangle, may be a shape that connects from the base electrode or the connection terminal electrode to the substrate with a straight line or may be a shape that connects with a curve. Any shape, as long as satisfying Formula 1 when the shortest distance passing through the surface of the insulating film 60, from the base electrode or the connection terminal electrode to a substrate without each functional film is represented by Tsr, may be applicable.

Herein, although an example in which the side surface 611 of the insulating film 60 is integrated with the side surface of the substrate is shown, when viewed in the z-axis direction, the substrate 20 may protrude from a portion in which the capacitor is provided. In such a case, a distance between a point on the upper surface 201 of the substrate 20 and an end portion of the base electrode or the connection terminal electrode is represented by the shortest distance Tsr.

It is to be noted that the configuration of each of the above exemplary embodiments is able to be appropriately combined, and advantageous functions and effects according to each combination are able to be obtained.

<1> A capacitor including a lower electrode, a dielectric body disposed on an upper surface of the lower electrode, an upper electrode disposed on an upper surface of the dielectric body and facing the lower electrode across the dielectric body, an externally connecting terminal electrode disposed on an upper surface of the upper electrode and electrically connected to the upper electrode, and an insulating film covering the upper electrode, the dielectric body, portion excluding an externally connecting portion of the terminal electrode, and a part of the lower electrode, and, when a thickness of the dielectric body is represented by Td and a shortest distance along a surface of the insulating film that connects a portion of the terminal electrode that is not covered with the insulating film and a portion of the lower electrode that is not covered with the insulating film is represented by Tsr, the thickness Td and the shortest distance Tsr satisfy a relationship of Tsr<18×Td².

<2> The capacitor according to <1> in which the terminal electrode includes a projection projecting in a top view from a side surface of a main portion of a predetermined shape, and the shortest distance Tsr is a distance between the projection and the lower electrode.

<3> The capacitor according to <2> in which the projection includes a plurality of projections disposed at positions that face each other across the main portion.

<4> The capacitor according to <2> or <3> in which the projection has a shape with a tapered front end.

<5> The capacitor according to any one of <1> to <3> in which the terminal electrode includes a base electrode electrically connected to the upper electrode, and an external connection electrode provided at the base electrode, the external connection electrode projects farther than a side surface of the base electrode, and a gap is present between a portion of the external connection electrode projecting farther than the side surface of the base electrode and the upper electrode.

<6> The capacitor according to any one of <1> to <5> in which the lower electrode is a conductive semiconductor substrate.

<7> The capacitor according to <6> in which the lower electrode includes a conductive film disposed between the conductive semiconductor substrate and the dielectric body.

<8> The capacitor according to any one of <1> to <5> in which the lower electrode includes an insulating substrate, and a conductive film disposed between the insulating substrate and the dielectric body.

<9> The capacitor according to any one of <1> to <8> in which the terminal electrode is electrically connected to the upper electrode and further includes a lower-electrode terminal electrode to be electrically connected to the lower electrode.

<10> The capacitor according to <6> or <7> in which the semiconductor substrate is made of Si, and the dielectric body is SiO₂.

### REFERENCE SIGNS LIST

10, 10A, 10B, 10C, 10D, 10E, 10F: capacitor
20, 20i: substrate
20e: electrode
30, 31, 32: dielectric body
40, 41, 41LP, 42, 42D, 42E: electrode
50: protective film
50LP: lower protective film
60: insulating film
70: power supply film
71, 71A, 71B, 71C, 72: base electrode
81, 81A, 81B, 81C, 82: external connection electrode
90: insulating film
201: upper surface
202: lower surface
419, 429: via conductor
501, 502: depression
601: upper surface
611, 613, 614: side surface
691, 692: depression
711, 711B, 712, 713, 714: side surface
791, 793, 794: projection
891B: side surface
7911, 7931, 7941: front end

1. A capacitor comprising:
a first electrode;
a dielectric body on a surface of the first electrode;
a second electrode on a surface of the dielectric body and facing the first electrode across the dielectric body;
an externally connecting terminal electrode on a surface of the second electrode and electrically connected to the second electrode; and
an insulating film covering the second electrode, the dielectric body, a portion excluding an externally connecting portion of the terminal electrode, and a part of the first electrode, wherein, when a thickness of the dielectric body is represented by Td and a shortest distance along a surface of the insulating film that connects a first portion of the terminal electrode that is not covered with the insulating film and a second portion of the first electrode that is not covered with the insulating film is represented by Tsr, Tsr<18×Td².

2. The capacitor according to claim 1, wherein:
the terminal electrode includes a projection projecting in a top view from a side surface of a main portion of the terminal electrode, and
the shortest distance Tsr is a distance between the projection and the first electrode.

3. The capacitor according to claim 2, wherein the projection is one of a plurality of projections disposed at positions that face each other across the main portion.

4. The capacitor according to claim 3, wherein the plurality of projections each have a shape with a tapered front end.

5. The capacitor according to claim 2, wherein the projection has a shape with a tapered front end.

6. The capacitor according to claim 1, wherein the terminal electrode includes:
a base electrode electrically connected to the second electrode; and
an external connection electrode on the base electrode.

7. The capacitor according to claim 6, wherein:
the external connection electrode projects farther than a side surface of the base electrode; and
a gap is present between a first portion of the external connection electrode projecting farther than the side surface of the base electrode and the second electrode.

8. The capacitor according to claim 1, wherein the first electrode is a conductive semiconductor substrate.

9. The capacitor according to claim 8, further comprising a conductive film between the conductive semiconductor substrate and the dielectric body.

10. The capacitor according to claim 1, wherein the first electrode includes:
an insulating substrate; and
a conductive film between the insulating substrate and the dielectric body.

11. The capacitor according to claim 1, further comprising:
a third electrode electrically connected to the first electrode; and
an another terminal electrode on a surface of the third electrode.

12. The capacitor according to claim 6, wherein:
the semiconductor substrate comprises Si, and
the dielectric body comprises SiO₂.

13. A capacitor comprising:
a conductive semiconductor substrate;
a first dielectric body on a surface of the conductive semiconductor substrate;
a second dielectric body on the surface of the conductive semiconductor substrate and separated from the first dielectric body;
a first electrode on a surface of the first dielectric body and facing the conductive semiconductor substrate across the first dielectric body;
a second electrode on a surface of the second dielectric body and electrically and physically connected to the conductive semiconductor substrate;
a first terminal electrode on a surface of the first electrode and electrically connected to the first electrode;
a second terminal electrode on a surface of the second electrode and electrically connected to the second electrode; and
an insulating film covering the first electrode, the second electrode, the first dielectric body, the second dielectric body, a portion excluding an externally connecting portion of at least one of the first terminal electrode and the second terminal electrode, and a part of the conductive semiconductor substrate, wherein, when a thickness of the first dielectric body is represented by Td and a shortest distance along a surface of the insulating film that connects a first portion of the first terminal electrode that is not covered with the insulating film and a second portion of the substrate that is not covered with the insulating film is represented by Tsr, Tsr<18×Td².

14. The capacitor according to claim 13, wherein:
first terminal electrode includes a projection projecting in a top view from a side surface of a main portion of the first terminal electrode, and
the shortest distance Tsr is a distance between the projection and the conductive semiconductor substrate.

15. The capacitor according to claim 14, wherein the projection is one of a plurality of projections disposed at positions that face each other across the main portion.

16. The capacitor according to claim 15, wherein the plurality of projections each have a shape with a tapered front end.

17. The capacitor according to claim 14, wherein the projection has a shape with a tapered front end.

18. The capacitor according to claim 13, wherein the first terminal electrode includes:
a base electrode electrically connected to the first electrode; and
an external connection electrode on the base electrode, wherein:
the external connection electrode projects farther than a side surface of the base electrode, and
a gap is present between a first portion of the external connection electrode projecting farther than the side surface of the base electrode and the second electrode.

19. The capacitor according to claim 18, further comprising a conductive film between the conductive semiconductor substrate and the dielectric body.

20. The capacitor according to claim 13, wherein the first electrode includes:
an insulating substrate; and
a conductive film between the insulating substrate and the dielectric body.
